(19) United States
(12) Patent Application Publication
(10) Pub. No.: US 2015/0345263 A1
(43) Pub. Date: Dec. 3, 2015

(54) STABILIZING CONTAMINANTS IN DRILL CUTTINGS

(71) Applicants: Ervin Merritt, Granbury, TX (US); R Steven Merritt, Granbury, TX (US)

(72) Inventors: Ervin Merritt, Granbury, TX (US); R Steven Merritt, Granbury, TX (US)

(73) Assignees: Ervin Merritt, Granbury, TX (US); R Steven Merritt, Granbury, TX (US)

(21) Appl. No.: 14/721,245

(22) Filed: May 26, 2015

Related U.S. Application Data
(60) Provisional application No. 62/003,231, filed on May 27, 2014.

(51) Int. Cl. E21B 43/02; E21B 33/138; B09C 1/08; E02D 3/12

(52) U.S. Cl. CPC E21B 43/025; E02D 3/12; E21B 33/138; B09C 1/08

(57) ABSTRACT

Drill cuttings obtained from oil and gas wells contain contaminants such as heavy metals and volatile organic compounds (VOCs). Such contaminants complicate the disposal of the drill cuttings. The drill cuttings can be reused in load bearing applications such as road subgrades and drill site pads by combining the drill cuttings with soil and a soil stabilizer. The soil stabilizer includes sulfuric acid and citrus stripper oil. Once the soil stabilizer is added to the soil-cuttings mixture, the mixture is compacted to reduce the voids. The soil stabilizer liquefies minerals in the soil-cuttings mixture which liquids fill in any remaining voids. The result is a consolidated treated soil that greatly reduces the leaching of the contaminants therefrom.

### FIELD OF THE INVENTION

The present invention relates to methods of stabilizing contaminants, such as heavy metals, in drill cuttings, and compositions thereof.

### BACKGROUND OF THE INVENTION

Most oil and gas wells are drilled using a drill bit that is rotated. A string of chill pipe extends from the surface of the earth into the well. The bit is at the bottom of the drill string. The drill string is rotated, thereby rotating the drill bit. As the drill bit rotates during drilling operations, the bit cuts and grinds the rock at the end of the well borehole, thereby creating cuttings.

During drilling, drilling mud is circulated inside the well. The mud is pumped down inside of the drill pipe and out through the drill bit and back to the surface by way of the annulus around the drill pipe. The drilling mud removes the cuttings created by the drill bit and brings the cuttings to the surface.

It is common to find that the drill cuttings are contaminated with undesirable materials, such as heavy metals and volatile organic compounds. Examples of undesirable metals include mercury and zinc. Examples of volatile organic compounds include benzene and toluene. Disposal of contaminated well cuttings can be difficult and expensive.

In the prior art cuttings are separated from the drilling mud and the drilling mud is then reused by recirculating the mud down the drill string. The drill cuttings are disposed of. One method of disposal involves hauling the cuttings to a landfill that is permitted to handle hazardous wastes. A permitted landfill may be distant from the well site, requiring transportation expenses in addition to the cost (such as tipping fees) of putting the material in the landfill.

Another prior art method involves adding one of more components to the drill cuttings for stabilization. Common additives are Portland cement, fly ash, lime and asphalt. The stabilized cuttings can then be used to build load bearing structures such as roads. The additives are bulky however and must be hauled to the work or construction site.

What is needed is a way to dispose of drill cuttings from oil and gas wells in a less expensive manner.

### SUMMARY OF THE INVENTION

A method of stabilizing and consolidating a soil containing contaminants such as heavy metals, comprises the steps of obtaining drill cuttings from an oil or gas well, the drill cuttings containing the contaminants; mixing the drill cuttings with soil to form a soil-cuttings mixture; mixing sulfuric acid, citrus stripper oil and water in a predetermined volumetric proportion to the soil-cuttings mixture to form a treated mixture that is satisfactorily packable; and packing the treated mixture to consolidate the soil and drill cuttings, wherein the leaching of the contaminants from the drill cuttings is reduced compared to the leaching of the contaminants from the untreated drill cuttings.

In accordance with one aspect, the predetermined volumetric proportion of the sulfuric acid to citrus stripper oil is between 70%:30% to 97%:3% by volume.

In accordance with another aspect, the sulfuric acid and the citrus stripper oil are premised before mixing with the soil-cuttings mixture.

In accordance with another aspect, the amount of moisture content of the treated mixture is the optimum moisture content.

In accordance with another aspect, the compressive strength of the treated soil-cuttings mixture is increased by at least 30% from the compressive strength of the untreated soil-cuttings mixture.

In accordance with another aspect, a pozzolan is mixed into the soil-cuttings mixture.

In accordance with another aspect, the step of mixing a pozzolan into the soil-cuttings mixture, further comprises the step of mixing no more than 5% by volume of Portland cement into the soil-cuttings mixture.

In accordance with another aspect, wherein less than 4% of lead leaches from the consolidated soil.

A composition of stabilized soil containing contaminants such as heavy metals, comprises a packed and consolidated mixture of soil, drill cuttings obtained from an oil and gas well, sulfuric acid, citrus stripper oil and water, wherein the leaching of the contaminants from the drill cuttings is reduced compared to the leaching of the contaminants of the untreated drill cuttings.

In accordance with one aspect, the proportion of sulfuric acid to citrus stripper oil is within the range of 70%:30% to 97%:3% by volume.

### DESCRIPTION OF THE PREFERRED EMBODINIENT

Drill cuttings can be disposed of by combining the cuttings with a soil. The soil-euttings mixture is treated with a soil stabilizer and compacted. The treated soil mixture can be used for a load bearing application such as a subgrade for an unpaved road, a well pad, or other application.

The drill cuttings, which may be contaminated with heavy metals and volatile organic compounds (VOCs), can be reused in the application in such a manner that the contaminants are not leached out. The soil stabilizer consolidates the cuttings and contaminants with the soil in such a manner that minimizes leaching of the contaminants. Thus, drill cuttings which are contaminated can be disposed of in an economical and useful manner. Contaminants leaching into the environment can cause damage and present safety hazards. By minimizing contaminant leaching, the environment is protected.

Each of the components, drill cuttings, soil and the soil stabilizer, will be discussed in turn, followed by a discussion of the use of the soil stabilizer in conjunction with the drill cuttings and the soil to make a load bearing application or structure.

Drill cuttings, or well cuttings, are formed during drifting operations in an oil or gas well. A drill string is tipped at the bottom with the drill bit and inserted into the borehole. The drill string is rotated and weight put on the bit. The drill bit cuts into the rock and extends the borehole through the rock. As the drill bit rotates and cuts, the rock is broken and ground to form cuttings. The cuttings are formed from the rock that the borehole is extended into. The rock can be sedimentary, metamorphic and even igneous, or combinations of these types of rock. The size of the particles forming the cuttings depend on the type of rock that is being drilled into, as well as the type of drill bit. Other factors, such as stress on the rock, may affect the size of the particles. Examples of particle size range from sub-millimeter (fines) to several millimeters. Cuttings can include chunks of rock that break loose from the walls of the borehole.

The drill cuttings contain some amount of drilling mud. Drilling and is used in drilling operations. The drilling mud is pumped downhole through the drill string. The drilling mud exits the drill bit via orifices at the bottom of the drill string. The mud serves to cool the bit and remove the rock cuttings from the bottom of the borehole. The drilling mud and cuttings return to the surface of the earth through the annulus located around the drill string.

Drilling muds have a base fluid and weighting agents. The base fluid can be water based or oil based. If the base is of an oil type, the oil can be diesel, mineral oil or a synthetic oil based compound. The weighting agents vary. One example of a weighting agent is barite. Drilling mud can also contain a clay and a stabilizing organic material (for example lignite or lignosulfonate).

As the drilling mud circulates in the well, it may gain other components (for example metals and salts) from the surrounding rock.

As the drilling mud exits the well, it undergoes processing to remove much of the cuttings. The cuttings are then stored on the surface while the drilling mud is recirculated back into the well.

Separating the drill cuttings from the drilling mud typically involves vibrating screens such as shale shakers. The cuttings do not pass through the screens while the mud passes through. The screens shake in order to move the cuttings to one end of the shaker device for collection. One or more sets of shale shakers may be used with a first shaker having a coarse screen and the second shaker having a finer screen to capture drill cuttings that have passed through the first shaker. Other separation techniques and apparatuses can be used such as hydrocyclone desilters and desanders, mud cleaners that use a hydrocyclone which discharges onto a shaker with a fine screen, and rotary bowl decanting centrifuges. Still other devices can be used to separate the cuttings from drilling mud. For example, drying shakers, rotary cutting dryers (either horizontal or vertical), screw-type presses or centrifuges, can be used, either alone or in combination with any of the above apparatuses.

The processing of the drilling mud to remove cutting from the drilling mud results in drill cuttings with some amount of drilling mud contained therein. Thus, the drill cuttings contain some drilling mud. If desired, the drill cuttings can be washed to further reduce the amount of drilling mud contained therein.

The drill cuttings contain undesirable metals and volatile organic compounds. Examples of undesirable metals are antimony, arsenic, barium, beryllium, cadmium, chromium, copper, lead, manganese, mercury, nickel, selenium, silver and zinc.

Examples of volatile organic compounds include benzene, ethyl benzene, toluene and xylenes. In addition, the volatile organic, compounds can include petroleum hydrocarbons which are referred to as total petroleum hydrocarbons (TPH). These range from having a number of carbon atoms of 6 to 35 (designed as C6-C35).

The drill cuttings are typically stored in a pit. The water content of the drill cuttings may be too high for reuse in a load structure type of application. Therefore, the cuttings are dewatered. Dewatering can occur in several ways. The most common practice is to spread the cuttings out over ground in order to allow them to air dry.

The soil that is mixed with the drill cuttings is of the type that is typically used to make the load bearing application or structure. The soil is a cohesive soil. A cohesive soil, once treated with the stabilizer, maintains its form and resists deformation under loads. Cohesive soils contain clay and may have some silt. Plasticity index is a useful indication of suitable soils. The soil should have a plasticity index of at least 7.

The soil can be obtained from a local source (native soil) or from a remote source. For example, if native soil is suitable, cut and fill operations can be used to create a level well pad site or road subgrade. Soil is removed from higher locations and moved to lower locations. If the native soil is insufficient or unsuitable, then soil is brought in from a remote source, typically by dump truck. The new soil can be mixed with the native soil to make a suitable cohesive soil. The soil is evened out to create a level well pad site or the appropriate road subgrade.

In the preferred embodiment, drill cuttings are mixed with soil in amounts ranging from 20-40% cuttings to 60-80% soil (by volume). A typical type of application would involve forming a road subgrade ten inches thick. Six inches of soil would be prepared for the subgrade. When ready, four inches of drill cuttings would be placed on top of the soil, to create a 60-40% ratio of soil to cuttings. The drill cuttings are mixed in with the soli such as by using a reclaimer or a pulverizing machine. Drill cuttings may be used to enhance the cohesiveness of the soil-cuttings mixture. Instead of having a new soil from a remote location, drill cuttings can be used to increase the plasticity index or otherwise make a cohesive soil.

The moisture content of the soil-cuttings mixture is tested. The moisture content before compaction should be at or near the soil-cuttings mixture's optimum moisture content (OMC). The OMC allows effective compaction of the mixture. The OMC of the soil-cuttings mixture varies according to the specific type of soils. For example, granular soils have an OMC of about 6-8%, while clay soils have an OMC of about 25-30%. The OMC of the soil-cuttings mixture is determined based on the moisture of the mixture after the stabilizer has been added (the stabilizer is diluted with water). In practical application, the actual moisture content of the mixture falls within a tolerance of the specified OMC for example, ±2%). If the moisture content is too high, the soilcuttings mixture is allowed to dry. Remixing of the soil-cuttings mixture may be required in order to turn the soil over to allow better drying. If the moisture content is too low, water is added such as by spraying from a water truck.

The soil stabilizer is described Merritt, U.S. Pat. No. 4,941,924, the entire disclosure of which is incorporated herein by reference. The stabilizer includes sulfuric acid and citrus stripper oil. The stabilizer may optionally include other components such as a surfactant and a corrosion inhibitor.

In the preferred embodiment, the stabilizer is:

| | |
|---|---|
| Sulfuric Acid | 85% |
| Citrus Stripper Oil | 8% |
| Surfactant | 6% |
| Corrosion Inhibitor | 1% |
| | 100% by volume |

The sulfuric acid is concentrated, being of the 1835 BE grade. Citrus stripper oil is also known as d-limonene, as it contains 94-98% d-limonene. Citrus stripper oil is obtained as a byproduct in the manufacture of citrus products.

The surfactant is a non-ionic surfactant. In the preferred embodiment, the surfactant is nonylphenol polyethylene glycol ether NP-9. The corrosion inhibitor in the preferred embodiment is 1,3-diethylthiourea.

Although the preferred ratio of sulfuric acid to citrus stripper oil is given above, other ratios include 70%-97% sulfuric acid and 3%-30% citrus stripper oil.

The application rate of the stabilizer can be taken from the following chart.

| Road Width in Feet | 6″ in Depth | | 8″ in depth | | 10″ in Depth | |
|---|---|---|---|---|---|---|
| 20′ wide road | 66 | gallons per mile | 88 | gallons per mile | 109 | gallons per mile |
| 22′ wide road | 73 | gallons per mile | 97 | gallons per mile | 120 | gallons per mile |
| 24′ wide road | 79 | gallons per mile | 106 | gallons per mile | 131 | gallons per mile |
| 26′ wide road | 85 | gallons per mile | 115 | gallons per mile | 142 | gallons per mile |
| 28′ wide road | 92 | gallons per mile | 124 | gallons per mile | 153 | gallons per mile |
| 30′ wide road | 99 | gallons per mile | 132 | gallons per mile | 163 | gallons per mile |
| Square yards | 180 | square yards | 135 | square yards | 108 | square yards |
| treated/gallon | | | | | | |
| Square yards | 171 | square yards | 128 | square yards | 103 | square yards |
| treated/gallon | | | | | | |
| (when, using | | | | | | |
| cement) | | | | | | |

The use of the soil stabilizer increases the compressive strength of the soil-cutting mixture by at least 30-40%. Compressive strength is dependent upon the type of soil used.

A pozzolan, such as Portland cement, is used to increase the load bearing capability and compressive strength of the soil. For example, if the plasticity index of the soil-cuttings mixture is 21 or less, then Portland cement can be used. If Portland cement is used, the amount is 2-5% by volume. In addition to Portland cement, other pozzolans, such as lime, fly ash, etc. can be used. The pozzolan can be applied to the soil-cuttings mixture before, during or after the application of the stabilizer.

if the soil is suitable, it is preferred that Portland cement not be used as Portland cement itself contains heavy metals. Therefore, the use of Portland cement in the stabilized soil actually increases the amount of heavy metals above and beyond what is contained in the drill cuttings.

Portland cement and other pozzolans have traditionally been used to increase the load bearing capacity of soils. By using the soil stabilizer to consolidate and stabilize soil, the amount of Portland cement required to obtain a desired load bearing capacity and compressive strength is significantly reduced. Thus, the amount of heavy metals added to the soil can be significantly reduced over traditional methods.

Once the soil-cuttings mixture is ready and at the proper moisture content, the stabilizer is applied. The stabilizer is diluted with water in the range of 100:1 to 300:1 water destabilizer by volume (for example, one gallon of stabilizer is diluted into 100 gallons of water). The amount of water added to the soil along with the stabilizer is included in the moisture content calculation of the soil-cuttings mixture.

The diluted stabilizer is applied to the soil-cuttings mixture by way of a water truck. The water truck traverses the surface, spraying the diluted stabilizer on top at the desired application rate. Once the diluted stabilizer is applied, the stabilizer is mixed into the soil using a pulverizer or reclaimer. Once the stabilizer is mixed into the soil-cuttings mixture, then a compactor such a roller is used to compact the soil.

As an alternative to in situ mixing, the soil, cuttings and stabilizer can be mixed in a mixer and then applied to the ground.

As mentioned, the soil-cuttings mixture can be used in a load bearing application such as a road subgrade or well pad site. Cuttings from a first well previously drilled can be used in the well pad and access road for a second subsequent well. This is particularly useful if the two well sites are close together.

A topping can be applied to the stabilized soil-cuttings mixtures. Crushed rock can be used as a topping. Crushed rock is commonly used as a top layer on well pad sites and access roads. Other toppings can be used, such as asphalt, particularly on access roads.

The soil stabilizer liquefies some of the minerals in the soil-cuttings mixture. When the soil-cuttings mixture is compacted after adding the stabilizer the air voids are greatly reduced. The liquefied minerals fill the remaining voids or gaps between the particles of soil and cuttings. This forms a compact, consolidated mixture that resists leaching of heavy metals and volatile organic compounds. The leaching is greatly reduced in the stabilized soil-cuttings mixture when compared to the same soil-cuttings mixture that has not been treated with stabilizer. Likewise, the leaching of contaminants is greatly reduced in the stabilized soil-cuttings mixture as compared to the other, untreated drill cuttings.

A toxicity characteristic leaching procedure (TCLP) test was conducted on a sample having 40% drill cuttings to 60% soil. The results are in Tables 1 and 2.

TABLE 1
Total and TCLP Metals In a 40% Drill
Cuttings to 60% Soil Mixture

| | Total Metals | TCLP Metals | |
|---|---|---|---|
| | mg/KG | mg/L | |
| Antimony | 2.7 | <0.0044 | 96.7 |
| Arsenic | 4.9 | <0.006 | 97.6 |
| Barium | 2600 | 0.36 | 99.7 |
| Beryllium* | <2.2 | 0.0003 | 99.7 |
| Cadmium* | 0.04 | 0.0017 | 15.0 |
| Chromium | 23 | 0.2 | 82.6 |
| Copper | 220 | 0.009 | 99.9 |
| Lead | 4.8 | <0.0068 | 97.2 |
| Manganese | 870 | 0.38 | 99.1 |
| Mercury* | 0.017 | <0.0053 | NA |
| Nickel | 18 | 0.017 | 98.1 |
| Selenium* | <0.35 | <0.0085 | 51.4 |
| Silver* | 0.26 | <0.0017 | 86.9 |
| Zinc | 38 | <0.0068 | 99.6 |

Note 1:
The percent retained on the soil was determined after the total was adjusted for the TCLP dilution
Note 2:
NA or * means that the total concentration of the metel was so low that the calculation was skewed

TABLE 2
VOC and TPH Concentrations in Raw
Cuttings and 40% Soil Mixture

| | Raw Cuttings | 40% Mixture | 40% Mixture |
|---|---|---|---|
| | Total | Total | TCLP |
| | mg/Kg | mg/Kg | mg/L |
| Benzene | 5.9 | <0.23 | <0.00036 |
| Ethyl benzene | 16000 | <0.29 | <0.00029 |
| Toluene | 1400 | <0.40 | <0.0006 |
| Xylenes | 49000 | <0.26 | <0.001 |
| TPH C6-C12 | 19000 | 1900 | — |
| TPH C12-C28 | 74000 | 20000 | — |
| TPH C28-C35 | 970 | 250 | — |
| TPH Total | 94000 | 22000 | — |

The test shows that less than 4% of the following metals leached from the treated, stabilized soil: antimony, arsenic, barium, beryllium, copper, lead, manganese, nickel and zinc. The VOCs and TPHs were leached in quantities so small as to be considered negligible.

The State of Texas currently requires the following leachate limitations:

| | | |
|---|---|---|
| Arsenic | <5.0 | mg/L |
| Barium | <100.0 | mg/L |
| Cadmium | <1.0 | mg/L |
| Chromium | <5.0 | mg/L |
| Lead | <5.0 | mg/L |
| Mercury | <0.2 | mg/L |
| Selenium | <1.0 | mg/L |
| Silver | <5.0 | mg/L |
| Benzene | <0.50 | mg/L |
| TPH | <100.0 | mg/L |

The test sample was well within this standard.

Thus, the treated soil-cuttings mixture not only stabilizes the soil and cuttings but greatly reduces leaching of contaminants. Use of the stabilizer is an effective way to handle drill cuttings.

The foregoing disclosure and showings made in the drawings are merely illustrative of the principles of this invention and are not to be interpreted in a limiting sense.

1. A method of stabilizing and consolidating a soil containing contaminants such as heavy metals, comprising the steps of:
a) obtaining drill cuttings from an oil or gas well, the drill cuttings containing the contaminants;
b) mixing the drill cuttings with soil to form a soil-cuttings mixture;
c) mixing sulfuric acid, citrus stripper oil and water in a predetermined volumetric proportion to the soilcuttings mixture to form a treated mixture that is satisfactorily packable; and
d) packing the treated mixture to consolidate the soil and drill cuttings, wherein the leaching of the contaminants from the drill cuttings is reduced compared to the leaching or the contaminants from the untreated drill cuttings.

2. The method of claim 1, wherein the predetermined volumetric proportion of the sulfuric acid to citrus stripper oil is between 70%:30% to 97%:3% by volume.

3. The method of claim 1, wherein the sulfuric acid and the citrus stripper oil are premixed before mixing with the soil-cuttings mixture.

4. The method of claim 1, wherein the amount of moisture content of the treated mixture is the optimum moisture content.

5. The method of claim 1, wherein the compressive strength of the treated soil-cuttings mixture is increased by at least 30% from the compressive strength of the untreated soil-cuttings mixture.

6. The method of claim 1, further comprises the step of mixing a pozzolan into the soil-cuttings mixture.

7. The method of claim 6, wherein the step of mixing a pozzolan into the soil-cuttings mixture, further comprises the step of mixing no more than 5% by volume of Portland cement into the soil-cuttings mixture.

8. The method of claim 1, wherein less than 4% of lead leaches from the consolidated soil.

9. A composition of stabilized soil containing contaminants such as heavy metals, comprising a packed and consolidated mixture of soil, drill cuttings obtained from an oil and gas well, sulfuric acid, citrus stripper oil and water, wherein the leaching of the contaminants from the drill cuttings is reduced compared to the leaching of the contaminants of the untreated drill cuttings.

10. The composition of claim 9, wherein the proportion of sulfuric acid to citrus stripper oil is within the range of 70%:30% to 97%:3% by volume.
